(19) United States
(12) Patent Application Publication
(10) Pub. No.: US 2018/0001843 A1
(43) Pub. Date: Jan. 4, 2018

(54) A Visual Theft Prevention and Connectivity System for a Vehicle, Facility or Home

(71) Applicant: JC&C Bowers Holdings Limited, Sherfield-on-Loddon; Hook, Hampshire (GB)

(72) Inventor: John Bowers, Sherfield-on-Loddon (GB)

(21) Appl. No.: 15/542,805

(22) PCT Filed: Jan. 11, 2016
(86) PCT No.: PCT/GB2016/000004

§ 371 Date: Jul. 11, 2017

(30) Foreign Application Priority Data
Jan. 11, 2015 (GB) 1500396.5
Feb. 11, 2015 (GB) 1502292.4
Feb. 12, 2015 (GB) 1502303.9
Mar. 11, 2015 (GB) 1504141.1
Oct. 7, 2015 (GB) 1517727.2

(51) Int. Cl. B60R 16/023; G07C 5/00; B60R 25/104; B60J 3/04; B60K 31/00; B60H 1/00; B60R 25/01; B60R 16/033; B60Q 1/04; G08G 1/0968; B60R 25/24; G06Q 40/08; G06Q 30/02

(52) U.S. Cl. CPC B60R 16/023; G08G 1/0968; G07C 5/008; G07C 5/006; B60R 25/104; B60J 3/04; B60K 31/00; B60R 25/24; B60H 1/00735; B60R 25/016; B60R 16/033; B60Q 1/04; B60K 2031/0091; G06Q 30/0265; G06Q 40/08

(57) ABSTRACT

A visual theft prevention system for a vehicle 1 comprises at least one sheet of automotive glass configured as a vehicle windscreen 2, and; at least one film layer attached to the at least one sheet of automotive glass, the film layer configured to have an active state where the film layer is substantially opaque, and an inactive state where the film layer is substantially transparent, the film layer shaped and sized such that when in the active state, the view of a user through the vehicle windscreen 2 is substantially blocked.

### FIELD

The present invention relates to a theft prevention and connectivity system for a vehicle, facility or home. More particularly, the present invention relates to a multi-state screen, that can be switched between a transparent and a non-transparent state. The present invention also relates to a film that can be fitted to an existing vehicle screen or facility/home window so that the screen can be switched between a transparent and a non-transparent state. The present invention further relates to an un-interruptible power supply and a secure key fob for a theft prevention and connectivity system for a vehicle, facility or home. The present invention yet still further relates to a vehicle, facility or home fitted with one or more of the preceding.

### BACKGROUND

Vehicle theft is a growing problem. Anti-theft systems and devices for vehicles are continually becoming more sophisticated in order to prevent vehicle theft, with the use of systems such as immobilisers becoming mandatory in certain countries and similar technologies becoming widespread on modern vehicles. Despite this, theft continues to increase. Certain vehicle makes and models are considered more desirable and fuel this illegal activity, or have security systems that are less difficult to circumvent than others. If the vehicle is not fitted with secondary protection, then it is easy to steal once the primary systems (those aimed at prohibiting entry) are bypassed. Recently, vehicles that use a keyless ignition system & RKE (Remote Keyless Entry) have been some of the most targeted models, as this type of security system can be bypassed using widely-available and inexpensive equipment such as RF scanners and cloning devices.

A number of specifications have been filed which describe device intended to address this issue.

WO1997/008025 describes and shows a windscreen for a motor vehicle which incorporates an electrochromatic material which renders all or part of the windscreen opaque when a sensor is activated by unauthorised entry or excessive disturbance. The window is kept transparent by means of an electric current flowing through the electrochromatic part of the windscreen.

GB2441137 describes and shows an anti theft system that uses electronically controlled glass (for example photochromatic or electrochromatic glass) to stop car thieves from seeing into the car, or, if entry is gained, prevent a would-be thief from being able to see to drive the car. The system is powered while the engine is running by an alternator/generator, or if the engine is switched off by a separate power source such as an additional battery or solar system. The system may be set for the windows to stay clear for a limited period of time while the engine is not running using the additional battery or solar system.

U.S. Pat. No. 5,495,224 describes and shows a method and apparatus for preventing automobile theft which includes structure for rendering the front windshield, or all the windows of the automobile, opaque. The opaqueness may be caused either by mechanical means, or alternatively, by utilizing liquid crystals or similar media.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

### SUMMARY

It is an object of the present invention to provide a theft prevention and connectivity system for a vehicle, facility or home which goes some way to overcoming the abovementioned disadvantages or which at least provides the public or industry with a useful choice.

It is a further object of the invention to provide a screen for a vehicle or facility/home window that can be switched between a transparent and a non-transparent state in order to assist with preventing theft which goes some way to overcoming the abovementioned. disadvantages or which at least provides the public or industry with a useful choice.

It is a yet still further object of the invention to provide a film that, can be fitted to an existing vehicle screen so that the screen can be switched between a transparent and a non-transparent state in order to assist with preventing theft which goes some way to overcoming the abovementioned disadvantages or which at least provides the public or industry with a useful choice.

It is a yet still further object of the invention to provide an un-interruptible power supply for a theft prevention and connectivity system for a vehicle, facility or home which goes some way to overcoming the abovementioned disadvantages or which at least provides the public or industry with a useful choice.

It is a yet still further object of the invention to provide a secure key fob for a theft prevention and connectivity system for a vehicle, facility or home which goes some way to overcoming the abovementioned disadvantages or which at least provides the public or industry with a useful choice.

It is a yet still further object of the invention to provide a vehicle fitted with a theft prevention and connectivity system which go some way to overcoming the abovementioned disadvantages or which at least provides the public or industry with a useful choice.

The term “comprising” as used in this specification and indicative independent claims means “consisting at least in part of”. When interpreting each statement in this specification and indicative independent claims that includes the term “comprising”, features other than that or those prefaced by the term may also be present. Related terms such as “comprise” and “comprises” are to be interpreted in the same manner.

As used herein the term “and/or” means “and” or “or”, or both.

As used herein “(s)” following a noun means the plural and/or singular forms of the noun.

Accordingly, in a first aspect the present invention may broadly be said to consist in a theft prevention system for a vehicle, comprising:
at least one sheet of automotive glass configured as a vehicle screen;
at least one film layer attached to the at least one sheet of automotive glass, the film layer configured to have an active state where the film layer is substantially opaque, and an inactive state where the film layer is substantially transparent, the film layer shaped and sized such that when in'the active state, the view of a user through the vehicle windscreen is substantially blocked, and;

a plurality of wireless communication devices and at least one processor, the wireless communication devices and the at least one processor configured for inter-communication, the at least one processor further configured to control the state of the film layer, at least one of the wireless communication devices physically separate from the remainder of the theft prevention system, the wireless communication devices and processor configured so that communication between the physically separate device and at least one other integral device is required before the processor will switch the film layer to the inactive state.

In an embodiment, the film layer is configured to receive an electric current, and to switch between states on the application of current, the at least one processor further configured to control current flow to the film layer.

In an embodiment, the application of electric current causes the film layer to switch from the active state to the inactive state.

In an embodiment, the film layer is an LCD/SDP/PNLC/PRLC/PDLC film.

In an embodiment, the film layer is sandwiched between two sheets of automotive glass.

In an embodiment, the film layer is configured to cover substantially the entirety of the vehicle screen.

In an embodiment, the film layer is configured to form a pattern across at least part of the vehicle screen.

In a second aspect, the invention may broadly be said to consist in a vehicle, comprising a theft prevention system as outlined in any one of the statements above.

In a third aspect, the invention may broadly be said to consist in a vehicle, comprising:
at least one sheet of automotive glass configured as a windscreen for the vehicle;
at least one film layer attached to the at least one sheet of automotive glass, the film layer configured to have an active state where the film layer is substantially opaque, and an inactive state where the film layer is substantially transparent, the film layer shaped and sized such that when in the active state, the view of a user through the vehicle windscreen is substantially blocked, and;
a plurality of wireless communication devices and at least one processor, the wireless communication devices and the at least one processor configured for inter-communication, the at least one processor further configured to control the state of the film layer, at least one of the wireless communication devices physically separate from the remainder of the theft prevention system, the wireless communication devices and processor configured so that communication between the physically separate device and at least one other integral device is required before the processor will switch the film layer to the inactive state.

In an embodiment, the film layer is configured to receive an electric current, and to switch between states on the application of current, the at least one processor further configured to control current flow to the film layer.

In an embodiment, the application of electric current causes the film layer to switch from the active state to the inactive state.

In an embodiment, the film layer is an LCD/SDP/PNLC/PRLC/PDLC film.

In an embodiment, the film layer is sandwiched between two sheets of automotive glass.

In an embodiment, the film layer is configured to cover substantially the entirety of the vehicle screen.

In an embodiment, the film layer is configured to form a pattern across at least part of the vehicle screen.

In an embodiment, the at least one other integral wireless communication device is located within the vehicle ignition circuit.

In an embodiment, a further wireless communication device is located within the vehicle engine bay.

In an embodiment, a further wireless communication device is located within the vehicle frame.

In an embodiment, a further wireless communication device is located within the windscreen unit.

In an embodiment, the further wireless communication device is located within the windscreen surround.

In an embodiment, the further wireless communication device is located within the windscreen electronic housing.

In an embodiment, the physically separate device is located in a key fob.

In an embodiment, the vehicle further comprises a secondary power supply configured to supply non-motive electrical power to the vehicle in the event of failure of the main vehicle power supply.

In an embodiment, the secondary power supply comprises at least two batteries.

In an embodiment, the secondary power supply further comprises a split charge system configured to charge the batteries via the vehicle main power supply.

In an embodiment, the split charge system is configured to preferentially charge the battery lowest on power.

In an embodiment, the split charge system comprises feedback protection configured to ensure that the backup batteries cannot back feed into the vehicle main power system or each other.

In an embodiment, the secondary power supply is configured to maintain one battery on standby and one in use, and to switch between the batteries at pre-set intervals.

In an embodiment, the secondary power supply further comprises at least two inverters configured to alter the DC current from the batteries to an AC current.

In an embodiment, the inverters are configured to alter the current to substantially between 60 and 80 Volts AC at substantially 0.05 Amps.

In an embodiment, the inverters are configured to alter the current to a square wave output at substantially 50 Hz.

In a fourth aspect, the invention may broadly be said to consist in a theft prevention system for a vehicle, comprising:
a plurality of wireless communication devices and at least one processor, the wireless communication devices and the at least one processor configured for inter-communication, at least one of the wireless communication devices physically separate from the remainder of the theft prevention system, the wireless communication devices configured so that communication between the devices is required before operation of the vehicle can take place.

In an embodiment, at least one of the wireless communication devices is located within the vehicle ignition circuit.

In an embodiment, at least one of the wireless communication devices is located within the vehicle engine bay.

In an embodiment, at least one of the wireless communication devices is located within the vehicle frame.

In an embodiment, at least one of the wireless communication devices is located within the screen unit.

In an embodiment, the wireless communication device is located within the windscreen surround.

In an embodiment, the further wireless communication device is located within the windscreen electronic housing.

In an embodiment, the at least one processor is configured for communication with the main vehicle CAN BUS.

In an embodiment, the wireless communication devices are secondary semi-conductors.

In an embodiment, the wireless communication devices are near-field communication devices.

In an embodiment, the wireless communication devices are configured to encrypt information at substantially 128 bits.

In an embodiment, the wireless communication devices are further configured to store encrypted information.

In an embodiment, the physically separate device is located in a vehicle key fob.

In an embodiment, the fob comprises an encrypted data store configured to store a unique ID within the fob, accessible through password protection by a reader.

In an embodiment, the encrypted data store comprises flash storage within the fob,

In an embodiment, a one of the wireless communication devices is configured to in use locate within the vehicle remotely from the remainder of the wireless communication devices, and is configured to ensure that the theft prevention system remains fitted within the vehicle to which it was originally fitted.

In an embodiment, the processor is configured with core functions that comprise one or more of: encryption, decryption, random number generation, digital signatures and other utilities protocols.

In an embodiment, the algorithms within the processor comprise Hash algorithms (SHA-1, MD5 and X9.82 RNG), Symmetric-key encryption/decryption (AES, Triple-DES) and Asymmetric key encryption/decryption (RSA, DSA, Diffie-Hellman).

In an embodiment, the theft prevention system further comprises a communication assembly configured to read the wireless communication devices.

In an embodiment, the communication assembly comprises a Near-Field reader/transmitter.

In an embodiment, the communication assembly further comprises a GSM or 2G/3G/4G transmitter/receiver configured to allow the communication assembly to interact with a GSM or 2G/3G/4G network.

In a fifth aspect, the invention may broadly be said to consist in the vehicle as outlined above in the paragraphs relating to the second aspect, further comprising the theft prevention system as outlined above in the paragraphs relating to the fourth aspect.

In a sixth aspect, the invention may broadly be said to consist in a burglary prevention system for a facility or home, comprising:
at least one sheet of glass configured as a window;
at least one film layer attached to the at least one sheet of glass, the film layer configured to have an active state where the film layer is substantially opaque, and an inactive state where the film layer is substantially transparent, the film layer shaped and sized such that when in the active state, the view of a user through the window is substantially blocked, and;
a plurality of wireless communication devices and at least one processor, the wireless communication devices and the at least one processor configured for inter-communication, the at least one processor further configured to control the state of the film layer, at least one of the wireless communication devices physically separate from the remainder of the burglary prevention system, the wireless communication devices and processor configured so that communication between the physically separate device and at least one other integral device is required before the processor will switch the film layer to the inactive state.

In an embodiment, the film layer is configured to receive an electric current, and to switch between states on the application of current; the at least one processor further configured to control current flow to the film layer.

In an embodiment, the application of electric current causes the film layer to switch from the active state to the inactive state.

In an embodiment, the film layer is an LCD/SDP//PNLC/PRLC/PDLC film.

In an embodiment, the film layer is sandwiched between two sheets of glass.

In an embodiment, the film layer is configured to cover substantially the entirety of the window.

In an embodiment, the film layer is configured to form a pattern across at least part of the window.

In a seventh aspect, the invention may broadly be said to consist in a facility or home, comprising a theft prevention system as outlined in any one of the paragraphs relating to the sixth aspect.

In an eighth aspect, the invention may broadly be said to consist in a facility or home, comprising:
at least one sheet of glass configured as a window;
at least one film layer attached to the at least one sheet of glass, the film layer configured to have an active state where the film layer is substantially opaque, and an inactive state where the film layer is substantially transparent, the film layer shaped and sized such that when in the active state, the view of a user through the window is substantially blocked, and;
a plurality of wireless communication devices and at least one processor, the wireless communication devices and the at least one processor configured for inter-communication, the at least one processor further configured to control the state of the film layer, at least one of the wireless communication devices physically separate from the remainder of the theft prevention system, the wireless communication devices and processor configured so that communication between the physically separate device and at least one other integral device is required before the processor will switch the film layer to the inactive state.

In an embodiment, the film layer is configured to receive an electric current, and to switch between states on the application of current, the at least one processor further configured to control current flow to the film layer.

In an embodiment, the application of electric current causes the film layer to switch from the active state to the inactive state.

In an embodiment, the film layer is an LCD/SDP/PNLC/PRLC/PDLC film.

In an embodiment, the film layer is sandwiched between two sheets of glass.

In an embodiment, the film layer is configured to cover substantially the entirety of the window.

In an embodiment, the film layer is configured to form a pattern across at least part of the window.

In an embodiment, the at least one other integral wireless communication device is located within the facility/home electric circuit.

In an embodiment, a further wireless communication device is located within the structure of the facility/home structure.

In an embodiment, the further wireless communication device is located within a wall.

In an embodiment, the physically separate device is located in a key fob.

In an embodiment, the facility or home further comprises a secondary power supply configured to supply electrical power to the system in the event of failure of the main facility/home power supply.

In an embodiment, the secondary power supply comprises at least two batteries.

In an embodiment, the secondary power supply further comprises a split charge system configured to charge the batteries via the facility/home main power supply.

In an embodiment, the split charge system is configured to preferentially charge the battery lowest on power.

In an embodiment, the split charge system is configured to provide feedback protection to ensure that the backup batteries cannot back feed into the facility/home main power system or each other.

In an embodiment, the secondary power supply is configured to have one battery on standby and one in use, and to switch between the batteries at pre-set intervals.

In an embodiment, the tertiary power supply further comprises at least two inverters configured to alter the current to AC output.

In an embodiment, the inverters are configured to alter the current to substantially between 60 and 80 Volts AC at substantially 0.05 Amps.

In an embodiment, the inverters are configured to alter the current to a square wave output at substantially 50 Hz.

In a ninth aspect, the invention may broadly be said to consist in a connectivity and remote access system for a vehicle, comprising:
a plurality of wireless communication devices and at least one processor, the wireless communication devices and the at least one processor configured for inter-communication, at least one of the wireless communication devices physically separate from the remainder of the system, the wireless communication devices and processor configured so that communication between the physically separate device and at least one other integral device is required before the processor will authenticate the user for system use.

In an embodiment, the at least one other integral wireless communication device is located within the vehicle ignition circuit.

In an embodiment, a further wireless communication device is located within the vehicle engine bay.

In an embodiment, a further wireless communication device is located within the vehicle frame.

In an embodiment, the physically separate device is located in a key fob.

In an embodiment, the connectivity and remote access system further comprises a secondary power supply configured to supply non-motive electrical power to the vehicle in the event of failure of the main vehicle power supply.

In an embodiment, the secondary power supply comprises at least two batteries.

In an embodiment, the secondary power supply further comprises a split charge system configured to charge the batteries via the vehicle main power supply.

In an embodiment, the split charge system is configured to preferentially charge the battery lowest on power.

In an embodiment, the split charge system has feedback protection configured to ensure that the backup batteries cannot back feed into the vehicle main power system or each other.

In an embodiment, the secondary power supply is configured to have one battery on standby and one in use, and to switch between the batteries at pre-set intervals.

In an embodiment, the secondary power supply further comprises at least two inverters configured to alter the DC current from the batteries to an AC current.

In an embodiment, the inverters are configured to alter the current to substantially between 60 and 80 Volts AC at substantially 0.05 Amps.

In an embodiment, the inverters are configured to alter the current to a square wave output at substantially 50 Hz.

In an embodiment, the processor is configured to enable the remote and localised activation and de-activation of the vehicle's headlights depending on the ambient light at the vehicles location, using weather data or similar, processed in a server environment.

In an embodiment, the processor is configured to enable the remote and localised activation, de-activation and personalisation of a vehicle's climate control system depending on the ambient temperature at the vehicles location, using weather data or similar, processed in a server environment.

In an embodiment, the processor is configured to enable the remote and localised scanning of a vehicle for diagnostic, checking in/out and information purposes using Near Field Communication (NFC).

In an embodiment, the processor is configured to enable the automated notification to a roadside breakdown service, of a vehicle breakdown which is identified through the processing of information received from the vehicle's Controller Area Network (CAN) and information processed by the connectivity and remote access system, such as the vehicle location.

In an embodiment, the processor is configured to enable contextual advertisement announcements via the vehicle's in-car entertainment system, which are sent to the vehicle following processing in a server environment using information such as the driver profile and vehicle location.

In an embodiment, the processor is configured to impose limits on the vehicle depending on pre-set levels set by a third party such as the vehicle insurer. For example, the set of a maximum speed limit of 60 mph for new drivers.

In an embodiment, the processor is configured to create and update profiles of drivers using information received from the vehicle's Controller Area Network (CAN), such as speed, and information processed by the connectivity and remote access system, such as the vehicle location. This profile is then used as a theft identification method and/or supporting information for a third party service, such as vehicle insurance.

In an embodiment, the processor is configured to warn drivers of a high risk route or parking location through the notification of a warning on a smart device or an in-par entertainment system, which is received following information being processed within in a server environment.

In an embodiment, the processor is configured to warn drivers of a requirement to replace a part or complete a service depending on the processing of information received from the vehicle's Controller Area Network (CAN) and the recording of information on to a system by the driver and/or a third party, such as a repair garage.

In a tenth aspect, the invention may broadly be said to consist in a vehicle, comprising a connectivity and remote access system as outlined in any one of the statements relating to the ninth aspect.

In an eleventh aspect, the invention may broadly be said to consist in a connectivity and remote access system for a facility or home, comprising:
a plurality of wireless communication devices and at least one processor, the wireless communication devices and the at least one processor configured for inter-communication, at least one of the wireless communication devices physically separate from the remainder of the system, the wireless communication devices and processor configured so that communication between the physically separate device and at least one other integral device is required before the processor will authenticate the user for system use.

In an embodiment, at least one of the integral wireless communication device is located within the facility/home electrical circuit.

In an embodiment, at least one of the wireless communication device is located within the facility/home structure.

In an embodiment, the physically separate device is located in a key fob.

In an embodiment, the connectivity and remote access system further comprises a secondary power supply configured to supply electrical power to the system in the event of failure of the main facility/home power supply.

In an embodiment, the secondary power supply comprises at least two batteries.

In an embodiment, the tertiary power supply further comprises a split charge system configured to charge the batteries via the facility/home main power supply.

In an embodiment, the split charge system is configured to preferably charge the battery lowest on power.

In an embodiment, the split charge system has feedback protection configured to ensure that the backup batteries cannot back feed into the facility/home main power system or each other.

In an embodiment, the secondary power supply is configured to have one battery on standby and one in use, and to switch between the batteries at pre-set intervals.

In an embodiment, the secondary power supply further comprises at least two inverters.

In an embodiment, the inverters are configured to alter the current to substantially between 60 and 80 Volts AC at substantially 0.05 Amps.

In an embodiment, the inverters are configured to alter the current to a square wave output at substantially 50 Hz.

In a twelfth aspect, the invention may broadly be said to consist in a facility or home, comprising a connectivity and remote access system as outlined in any one of the paragraphs relating to the eleventh aspect.

In a thirteenth aspect, the invention may broadly be said to consist in a security key fob for a vehicle, comprising:
a memory portion configured to store encrypted protocols;
a wireless communication device configured to transmit the encrypted protocols, and to receive similar encrypted protocols transmitted from at least one similar remotely located wireless communication device.

In an embodiment, the wireless communication device is configured to receive similar encrypted protocols, and to triangulate with, two similar remotely located wireless communication devices.

In an embodiment, the wireless communication device is configured to encrypt information at 128 bit or above.

In an embodiment, the security key fob further comprises a separate second encrypted memory portion accessible via a dedicated reader.

In an embodiment, the separate second encrypted memory portion is a flash storage memory.

In an embodiment, the second memory portion is configured to store an encrypted secondary unique ID.

In a fourteenth aspect, the invention may broadly be said to consist in a security key fob for a facility, home or vehicle comprising:
a memory portion configured to store encrypted protocols;
a wireless communication device configured to transmit the encrypted protocols, and to receive similar encrypted protocols transmitted from at least one similar remotely located wireless communication device;
an authentication system located within a server environment, configured to authenticate the key fob for use for multiple vehicles and/or facilities/homes.

In an embodiment, the wireless communication device is configured to receive similar encrypted protocols, and to triangulate with, two similar remotely located wireless communication devices.

In an embodiment, the wireless communication device is configured to encrypt information at 128 bit or above.

In an embodiment, the security key fob further comprises a separate second encrypted memory portion accessible via a dedicated reader.

In an embodiment, the separate second encrypted memory portion is a flash storage memory.

In an embodiment, the second memory portion is configured to store an encrypted secondary unique ID.

In a fifteenth aspect, the invention may broadly be said to consist in an uninterruptable power supply unit for a vehicle, comprising:
at least two batteries, configured to supply non-motive electrical power to the vehicle in the event of failure of the main vehicle power supply, with one battery on standby and one in use, the secondary power supply configured to switch between the batteries at pre-set intervals;
a split charge system configured to charge the secondary power supply batteries via the vehicle main power supply, and to preferentially charge the battery lowest on power.

In an embodiment, the split charge system comprises feedback protection configured to ensure that the backup batteries cannot back feed into the vehicle main power system or each other.

In an embodiment, the uninterruptable power supply unit for a vehicle further comprises at least two inverters configured to alter the DC current from the batteries to an AC current and to alter the current to substantially between 60 and 80 Volts AC at substantially 0.05 Amps, and the current to a square wave output at substantially 50 Hz.

In a sixteenth aspect, the invention may broadly be said to consist in an uninterruptable power supply unit for a facility or home, comprises:
at least two batteries, configured to supply electrical power to the vehicle in the event of failure of the main facility/home power supply, with one battery on standby and one in use, the secondary power supply configured to switch between the batteries at pre-set intervals;
a split charge system configured to charge the secondary power supply batteries via the facility/home main power supply, and to preferentially charge the battery lowest on power.

In an embodiment, the split charge system comprises feedback protection configured to ensure that the backup batteries cannot back feed into the facility/home main power supply or each other.

In an embodiment, the uninterruptable power supply unit for a facility or home further comprises at least two inverters configured to alter the DC current from the batteries to an AC current and to alter the current to substantially between 60 and 80 Volts AC at substantially 0.05 Amps, and the current to a square wave output at substantially 50 Hz.

In a seventeenth aspect, the invention may broadly be said to consist in a theft prevention system for a vehicle, comprising:
at least one sheet of automotive glass configured as a vehicle rear screen;
at least one LCD/SDP/PNLC/PRLC/PDLC film layer attached to the at least one sheet of automotive glass, the film layer configured to have an active state where the film layer is substantially opaque, and an inactive state where the film layer is substantially transparent, the film layer shaped and sized such that when in the active state, the view of a user through the vehicle windscreen is substantially blocked, and;
at least one processor configured to control the state of the film layer through the application of electrical current, depending on the vehicle's reversing gear being selected.

In an eighteenth aspect, the invention may broadly be said to consist in a customisable vehicle screen design, comprising:
at least one sheet of automotive glass configured as a vehicle screen or window;
at least one LCD/SDP/PNLC/PRLC/PDLC film layer attached to the at least one sheet of automotive glass, the film layer configured to have an active state where the film layer is substantially opaque, and an inactive state where the film layer is substantially transparent;
at least one processor configured to control the state of the film layer through the application of electrical current, depending on the vehicle theft prevention system or user activation;
the film layer shaped and sized such that when in the active state, the view of a user through the vehicle windscreen is substantially blocked in the shape, size and design as defined by the processor programmed.

With respect to the above description then, it is to be realised that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

This invention may also be said broadly to consist in the parts, elements and features referred to or indicated in the specification of the application, individually or collectively, and any or all combinations of any two or more said parts, elements or features, and where specific integers are mentioned herein which have known equivalents in the art to which this invention relates, such known equivalents are deemed to be incorporated herein as if individually set forth.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

### BRIEF DESCRIPTION OF THE FIGURES

Further aspects of the invention will become apparent from the following description which is given by way of example only and with reference to the accompanying drawings which show an embodiment of the device by way of example, and in which:

FIG. 1 shows a perspective view of a vehicle and user, the vehicle fitted with a theft prevention system according to an embodiment of the invention, the theft prevention system comprising a vehicle windscreen with an integral film layer that has an active state where the film layer is opaque, and an inactive state where the film layer is transparent, the film layer shaped and sized such that when in the active state, the view of a user through the vehicle windscreen is substantially blocked, the film layer shown in the active state.

FIGS. 2a and 2b show a close-up perspective view from the front of the vehicle screen of FIG. 1, with the screen shown in the transparent and opaque states, respectively.

FIGS. 3a and 3b show a close-up perspective view from the front of a vehicle screen similar to that shown in FIG. 1, the screen having an integral film layer that has an active state where the film layer is opaque, and an inactive state where the film layer is transparent, the film layer shaped and sized such that when in the active state, the view of a user through the vehicle windscreen is partly obstructed, the film layer shown in the transparent and opaque states, respectively.

FIGS. 4a and 4b show a perspective view from inside a building looking through a set of windows towards the exterior, the windows fitted with an integral film layer that has an active state where the film layer is opaque, and an inactive state where the film layer is transparent, the film layer shaped and sized such that when in the active state, the view of a user through the windows is substantially blocked, the film layer shown in the inactive (transparent) and active (opaque) states, respectively.

FIG. 5 shows a user completing the final step in fully deactivating the theft prevention system of any of FIGS. 1 to 3 by operating the ignition of the vehicle of FIG. 1.

FIG. 6 shows a perspective view of the vehicle of FIG. 1 in operation and moving, the theft prevention system inactive or deactivated so that a driver can operate the vehicle.

FIG. 7 shows a perspective view of an individual attempting to take the vehicle of FIG. 1 without the consent of the owner, by breaking into the vehicle, the theft prevention system active to prevent the individual from being able to operate the vehicle.

FIG. 8 shows a block schematic of the theft prevention system of the present invention, showing detail of the interconnections between the ignition switch, the screen, the vehicle main battery, a back-up power supply, and a control and communication network that includes a number of wireless communication devices.

FIG. 9 shows a schematic perspective view of some of the items that form the theft prevention system in this embodiment in position in a vehicle, showing detail of the location and interconnections between the battery, the screen, and the elements that make up the control and communication network, including the positioning of the wireless communication devices sets integral within the vehicle, one of the wireless communication devices located within the vehicle ignition circuit, one located within the vehicle engine, and one located within the windscreen unit.

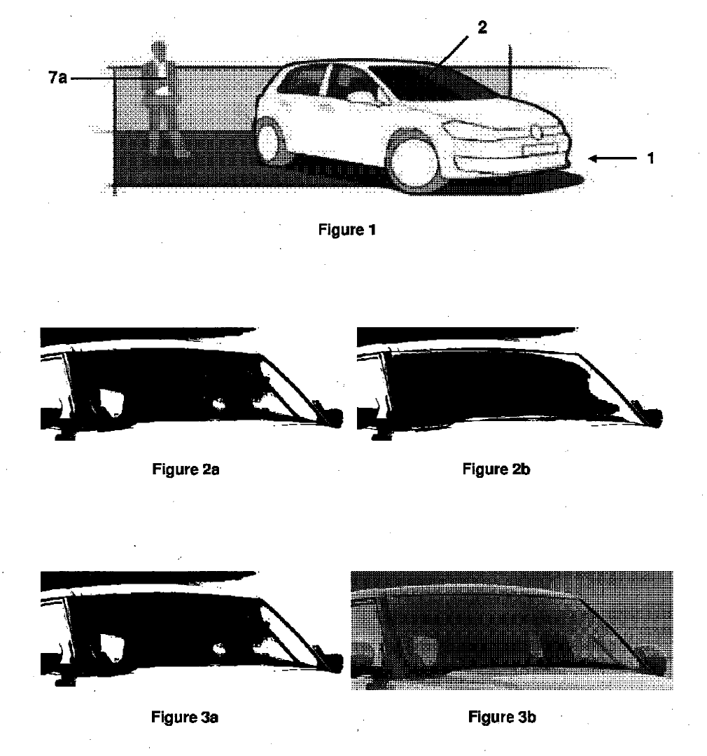

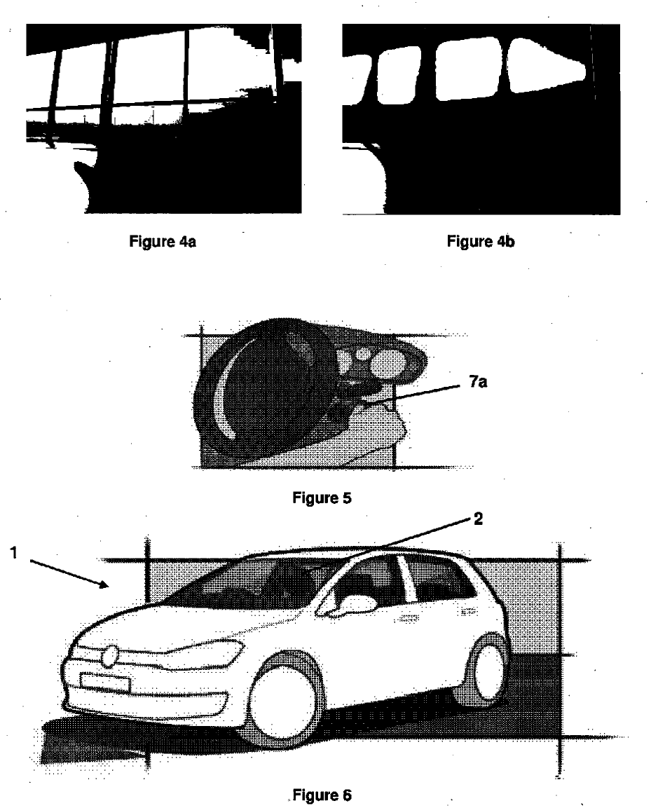

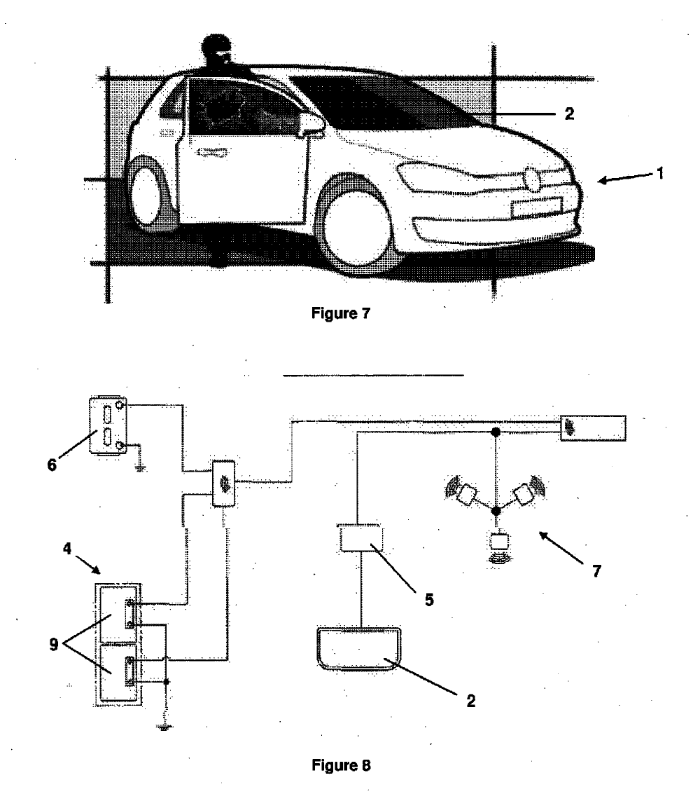

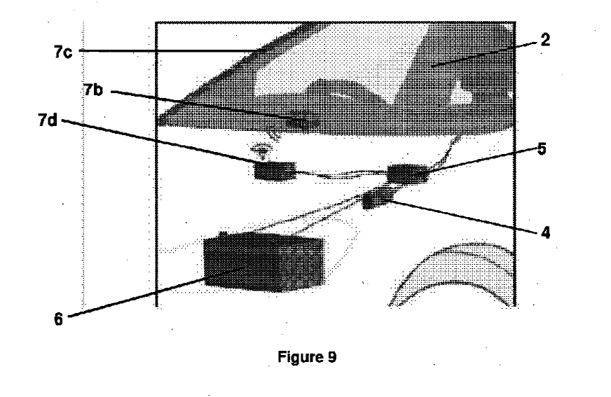

### DETAILED DESCRIPTION

Embodiments of the present invention will now be described with reference to the figures.

In a first embodiment, a vehicle 1 is fitted with a theft prevention system. The purpose of the theft prevention system is to provide a secondary level of security capability that operates in parallel with any other security such as remote keyless entry, or alarm, or a central locking facility. The windscreen 2 of this embodiment forms a part of the theft prevention system. In order to operate the vehicle 1, the windscreen 2 must be clear or transparent, so that the operator can see where they are going. In this embodiment, when the vehicle is in a neutral or non-operating state—that is, when the vehicle is parked and not in operation—the theft prevention system is active, and the windscreen 2 is opaque (that is, impervious to normal sight by a user: the windscreen 2 entirely or at least partly blocks the normal transmission of light through the windscreen 2 in order to prevent a user seeing through the windscreen 2 sufficiently to drive or otherwise operate the vehicle). The windscreen 2 becomes transparent on successful de-activation of the theft prevention system, allowing the operator to operate the vehicle. A user/operator de-activates the theft prevention system using the vehicle keys. ‘Transparent’ in this context should be taken to mean that the screen is clear enough to see through and to operate the vehicle safely—the windscreen meets or exceeds the required minimum light transmission rate (This is 75% in the United Kingdom—The UK Road Vehicles (Construction & Use) Regulations 1986 Act).

As noted above, the windscreen 2 forms part of the theft prevention system. In this embodiment, there are several other parts which are connected to the windscreen so that together they form the overall theft prevention system. The main elements that form the theft prevention system are:
a screen such as windscreen 2
a control and communication network 3
a power supply 4

These main elements, their sub-elements, and their interaction will now be described in detail.

Screen

In the embodiment described, the screen is windscreen 2. The windscreen is formed from two sheets of automotive grade glass, with a visually-active film located or sandwiched between the two sheets. In this embodiment, the layer of film is sandwiched between two or more layers of glass. However, in variations, the film could be attached to one (or both) sides of the glass. In this embodiment, in normal use, when a current is passed through the film, the film is clear and has a visual transparency rate greater than 75%. With no current, or on removal of the current, the film is opaque and has a visual transparency rate of 7% or below. In alternative embodiments, the states could be reversed so that transmittal of a current is required in order to cause the film to go opaque. In either case, in this specification, the ‘active’ or ‘operative’ state should be taken to refer to the opaque state, and ‘inactive’ or ‘inoperative’ or similar should be taken to refer to the transparent or use/operation state.

There are several types of film that can operate in this manner, such as for example a Liquid Crystal Display (LCD) film, Polymer Network Liquid Crystal (PNLC) film, Polymer Retiform Liquid Crystal (PRLC) film, Polymer Dispersed Liquid Crystal (PDLC) film, or Suspended Particle Device (SPD) film. In this embodiment, Polymer Retiform Liquid Crystal, or PRLC Switchable Film is used. This is formed from two layers of transparent conductive films sandwiched with polymer network liquid crystal material.

In these types of films, the liquid crystal PRLC is distributed in the polymeric three-dimensional network to form a continuous network of channels, rather than as spherical or ellipsoidal droplets. When the power is OFF, the crystals net block the light and the product appears shaded. When product is ON, the liquid crystal molecules align and light can penetrate through it. Thus, the product appears transparent.

These types of material are advantageous for this purpose, for a number of reasons:
The projection brightness remains the same at any angle.
Ultra Clear Transparency: Very low Haze (<3%).
The operating voltage is below a safe threshold.
Both front-projection and rear-projection properties are excellent, with a 360-degree visual angle.
They are very stable even with changes in temperature.
They do not delaminate unless externally damaged
The technical data for Liquid Crystal PRLC Film is included in the table below.

| Appearance | Colour | | Grey/Blue | |
|---|---|---|---|---|
| | Thickness | | 0.12 | mm |
| | Max Size | | Adhesive film | |
| | | | (1.2 × 30 m) | |
| | | | Non-Adhesive film | |
| | | | (1.2 × 50 m) | |
| Optical Property | Transparency | | ON: >93% | |
| | | | OFF <7% | |
| | Haze | | <3% | |
| | Visual Angle | | >160° C. | |
| Electrical-Property | Operating Voltage | | 15 V~36 V | |
| | Current | | 0.02 (A/m²) | |
| | Power Consumption | | 0.06(Watt/m²) | |
| | Responding Time | | ON-OFF and | |
| | | | OFF-ON: <0.05 s | |
| Specifications | Durable Temperature | | −30° C. to 70° C. | |
| PRLC Technical | PRLC (15-30 V) | | PRLC (60 V) | |
| | Good clarity | | Maximum clarity | |
| Sine Wave | | | | |
| Voltage | 30 | V | 60 | V |
| Hertz | 50/60 | Hz | 50/60 | Hz |
| Amps | 0.02 | A/m² | 0.02 | A/m² |
| Watts | 0.06 | W/m² | 0.0012 | W/m² |
| Square Wave | | | | |
| Voltage | 22 | V | 45 | V |
| Hertz | 50/60 | Hz | 50/60 | Hz |
| Amps | 0.02 | A/m² | 0.02 | A/m² |
| Watts | 0.06 | W/m² | 0.0012 | W/m² |
| Transformer Output | | | 10 | VA |
| Switching Speed | <0.05 | s | <0.05 | s |
| Haze | <3% | | <3% | |
| Angle of Vision | >160° | | >160° | |
| Film Thickness | 0.12 | mm | 0.12 | mm |
| Film type | Laminate | | Laminate | |
| Busbars | 4 | mm | 4 | mm |
| | Copper | | Copper | |
| Glass type | 2 | mm | 2 | mm |
| | Float or | | Float or | |
| | 2 | mm | 2 | mm |

| | |
|---|---|
| Low Iron | Low Iron |

A screen of this type will pass minimum LTR (Light Transmission Rate) regulations for most or all territories. Furthermore, a significant impact to the glass will result in failure to the immediate area only, leaving the remainder of the screen in working order.

The film can be arranged to extend over some or all of the surface area of the screen (e.g. blocking the driver's side, but leaving the passenger side clear). The film could be arranged as a unitary or solid planar item passing over some or all of the surface area, or arranged to form a pattern (e.g. square or hex grid, spiral, etc, or to spell out words such as ‘stolen’ or ‘secure’, or ‘call police’ or similar, or to display advertising or similar), or a combination of both (e.g. the film could be arranged on the driver's side to wholly or substantially cover the entirety of that side of the screen, and patterned on the passenger side). This would allow areas to be left clear to display stickers or badges within the vehicle, such as for example disabled passes or badges, security passes, vehicle tax badges and similar. This would also allow the film to be activated to act as a sun visor or similar (a strip along the top edge of the windscreen). This strip could be separate to the main anti-theft portion; so that this can be activated and de-activated during use by a user, and could be formed from a material that allows some visibility, rather than being wholly opaque.

Control and Communication System

The control and communication network 3 is a network of sub-devices that provides control and communications within the theft prevention system, and in particular for the windscreen 2. The network 3 forms part of a BUS or internal communications network for the theft prevention system, which is separate to the vehicle's CAN BUS. The network 3 runs in parallel to the vehicle's CAN BUS, and can interact with it (send and receive data and commands).

The control and communication network 3 in this embodiment comprises a number of separate elements:
a number of separate wireless communication devices or elements formed into a number of separate units (7a, 7b, 7c, 7d), with or without encryption.
the processor or processors 5, which will be described in detail below.
a central communication assembly 8 that transmits and receives to and from the separate wireless communication devices, and the processor 5. The central communication device 8 is also capable of communicating with the vehicle's CAN BUS.

Wireless Communication Devices

The separate wireless communication devices 7a, 7b, 7c, 7d are used in conjunction with the processor or processors 5, and a power supply 6 (e.g. the vehicle battery/power supply, or the separate power supply 4 for the theft prevention system as described below). The wireless communication devices could be for example secondary semi-conductors, near-field communication devices, or other similar devices capable of wireless communication over short distances. A first unit 7a of the wireless communication devices 7 is housed within the vehicle key or fob, with the remainder (7b-7d) forming sets that are located within the vehicle interior; and/or frame, and/or engine. In the preferred embodiment, the second set 7b is contained within the car ignition, and a third set 7c is contained within the windscreen (this set could alternatively be located in the windscreen surround or the windscreen electronic housing). Each of the sets 7a, 7b, 7c, 7d has an associated transmitter/receiver communication device so that they can communicate with the other sets, and with other peripheral items such as the processor or processors 5 via the central communication device 8.

The wireless communication devices 7 provide a security overlay. Direct communication is required between the sets 7a-7d in order for them to carry out actions. In use, each set of wireless communication devices 7 triangulates between the other sets, and the processor or processors 5.

For example, the first set 7a is configured to provide access to the vehicle. A user releases the lock by inserting their key/fob that contains the set 7a within a key recess or similar, or for example by pressing a button on the fob to transmit a signal. The first set 7a of the wireless communication devices 7 triangulates between the other sets 7b, 7c in the vehicle, and the processor 5. The processor 5 then instructs the opening/switching off of the vehicles central locking to provide access to the vehicle 1, as described in detail below. It should be noted that in the context of the control and communication network 3 described, ‘wireless’ should be taken to mean ‘capable of communication without direct hardwired connection’, or similar, rather than as a reference to a specific set of hardware and/or protocols. Suitable elements for use as the wireless communication devices 7 include, but are not limited to, NFC devices or tags, semiconductors, or a wireless interface that uses localised radio transmission. One advantage of using NFC elements is that the set within the key fob does not need to be powered—it does not need its own power source in order to provide the required functionality.

In the preferred form, the wireless communication devices 7 should have the ability to encrypt information at 128 bit. The wireless communication devices 7 also have the ability to store encrypted information such as for example a secondary unique ID, and to ‘password-protect’ information which can be unlocked or locked using a reader. The data stored on the wireless communication devices 7 is encrypted, and can be accessed via a reader as long as the correct password is known. The password can be issued by the vehicle. The wireless communication devices 7 can be remotely configured. One advantage of using NFC elements is that these can have a unique ID or identifier, which assists in preventing copying.

One of the tags (e.g. tag 7b) is located remotely from the remainder of the control and communication network 3. The purpose of this tag is to communicate with the other tags to ensure that the control and communication network 3 is located within the vehicle to which it was originally fitted.

Processor

The processor or processors 5 are configured to act as an overall control system for the theft prevention system, running routines and sub-routines and communicating with the field communication devices 7 or other peripheral items that form part of the theft prevention system.

In the preferred embodiment, the processors 5 are ARM technology-based microcontrollers, providing encryption and decryption of messages, digital signatures, and utilities protocols like key negotiation. Core features include confidentiality, which allows the sender and receiver to be sure that the information is being shared only in the way they intend; authentication, which allows the receiver of the information to be certain where it came from; and integrity, which allows the receiver to verify that the message has not been altered in transit.

Specific functionality of the processors 5 include encryption, decryption, random number generation, digital signatures and other utilities protocols to achieve benefits such as confidentiality, authentication, integrity and non-repudiation. The algorithms include Hash algorithms (SHA-1, MD5 and X9.82 RNG), Symmetric-key encryption/decryption (AES, Triple-DES) and Asymmetric key encryption/decryption (RSA, DSA, Diffie-Hellman).

The processors also include FPGA functionality.

The secure key/fob has multiple layers of authentication. Each key has a unique ID (for example as a function of using NFC devices), with encrypted data stored within flash storage within the key, accessed through password protection by the reader within the vehicle. If required, the key can be authenticated by a remote secure operating centre which confirms the association of the key and vehicle.

Central Communication Assembly

The central communication assembly 8 in the preferred embodiment comprises a Near-Field Communicator (reader/transmitter) capable of operating at ranges of up to 100 m. This allows the central communication assembly 8 to read the tags 7.

It is also preferred that the control and communication network 3 can communicate with a remote hub or location (e.g. a remotely-located server) via a GSM or 2G/3G/4G network, to provide location information and telematics, to receive updates for the firmware and software, to receive and carry out commands, and to receive temporary authentication codes to enable a user to use their vehicle in the event of a lost key or similar. The central communication assembly 8 in this embodiment therefore also comprises a GSM or 2G/3G/4G transmitter/receiver. All communication outside the immediate secure network inside the vehicle is encrypted using L2TP tools.

Operation

In use, the system operates as follows: the operator approaches their vehicle 1, carrying the key/fob, which contains set 7a. The key is used in the normal manner to unlock the doors of the vehicle (central locking). This allows the user access to the vehicle 1. However, they still cannot operate the vehicle 1 because the windscreen remains opaque. The user then inserts the key/fob into the ignition slot. The wireless communication devices 7 triangulate, and assess that the vehicle has been legally accessed (i.e. that the key is genuine). That is, the wireless communication device 7a in the key is remotely detected and authenticated. The control and communication network 3 triangulates, scanning for a range of protocols delivered by the set 7a, matching these with the expected protocols. Once the triangulation is complete and as the ignition is started/key inserted, the film is disengaged so that the opaque or impervious state changes to one of transparency and the vehicle 1 becomes operable. Should there be unlawful access of the vehicle (e.g. via a smashed window or if the key is not genuine (the key/fob has been cloned or otherwise copied), the film (and the windscreen) will remain in an opaque or impervious state. That is, if the required protocols cannot be scanned, or are not delivered, this is treated as a tamper or otherwise unauthorised attempt to deactivate the anti-theft system. Engine start is prevented and the screen remains opaque. The wireless communication devices 7 are not hackable in the same manner as the key fob, and therefore a thief cannot disengage the film. This makes vehicle theft more time consuming & complex to achieve. If a cloned key is used, the encrypted elements cannot be read (the required protocols cannot be scanned) by the other elements of the network within the vehicle, and this is treated as an unauthorised access attempt.

It can be seen that to operate the vehicle 1 in this embodiment, the operator must cause connection between their key/fob and the vehicle ignition. The ignition is configured to recognise when the key/fob is inserted. Once connection is made between key/fob and the ignition, a communication device that forms part of the ignition transmits a signal to and connects with the processor 5 and (either directly or via the processor 5) a communication device housed within the window screen electronic housing. The processor 5 registers when the connection is established, and transmits instructions so that an electronic current is sent to the windscreen 2 (or more specifically, the film within the windscreen 2). This turns the film within the windscreen 2 transparent, and allows a user to operate/drive the vehicle. The processor 5 also sends a signal to the main vehicle CAN BUS to activate or enable the ignition.

The wireless communication devices 7 ensure that vehicle component elements continuously have an independent communication capability and communication process, and have the frequency and processor capability to turn existing instruments and applications into overlaid security applications aimed at prohibiting vehicle operation. If a user does not have the vehicle keys, the immobiliser will remain impervious/activated and therefore prohibit vehicle operation. That is, the processor 5 can recognise when there has been an authentication failure and will ensure that the ignition remains deactivated and that the alarm remains active, as well as maintaining the screen in an opaque state.

As well as the core functions outlined above, the control and communication network 3 has the following functionality:
to track usage of the system—e.g. to count the number of arms/disarms, the number of unsuccessful disarm attempts, etc.
multiple redundancy of data and power routes within the network to ensure that commands and power can be diversely routed between points within the network, in order to mitigate cable risk.
ability to communicate with a remote hub or location (e.g. a remotely-located server) via a GSM or 2G/3G4G network, to provide location information and telematics, to receive updates for the firmware and software, to receive and carry out commands, and to receive temporary authentication codes to enable a user to use their vehicle in the event of a lost key or similar. All communication outside the immediate secure network inside the vehicle is encrypted using L2TP tools.
a user or other authorised party can program the system to remain active or in anti-theft mode for various periods of time—e.g. for certain periods such as overnight (e.g. midnight to 6 AM) as a regular repeating active window, or for one-off periods such as for example permanently on for a two-week period (while the user is away on a trip, on holiday, or similar). Within the pre-specified period, the system will remain active even if the correct key is used to deactivate the system. In these circumstances, the system will communicate with the remote control hub, which will contact the user by a separate channel such as e.g. telephone, and inform them of the access attempt. A user can then authorise access if the attempt is legitimate.
A ‘secure driver key’ can also be used, operating in a similar manner to the key and fob described above. However, the secure driver key can be assigned to the driver and a vehicle independently, promoting shared use of vehicles and allowing insurance, features and security profiles to be carried to any suitable vehicle with the driver.
The control system as described above can transmit usage data from the vehicle to the remote server or hub, to generate driver profiles using cloud machine learning over time. This can be used to help secure a vehicle from unauthorised use automatically.
Cloud-based information and environmental factors can be transmitted from the hub to the vehicle to alert the driver of possible threats related to the intended route of parking location of the vehicle, for the purpose of improving security and safety for the driver.
Advertising or similar information can be provided to a driver within the vehicle. This information can be targeted and contextual e.g. fuel station offers when the vehicle is low on fuel and located close to a petrol station, restaurant offers when it is close to lunch or dinner time, etc.

The ability to communicate with a remote hub or location allows third parties such as a repair garage to access the vehicle to carry out maintenance and repairs. Typically, two verification steps are used for remote commands sent to the vehicle. Firstly, an initial verification request (by the third party such as a garage) is sent to the remote server or command centre. Once this is approved, it is forwarded to the car owner or similar authorised party. Once the authorised party has positively approved the request, the third party can proceed.

Power Supply

The main purpose of the power supply 4 is to act as a secondary or fail-over power supply. This ensures that vehicle component elements are continuously supplied with power—power supply 4 acts an uninterruptible power supply.

The power supply 4 is connected to and charged by the main vehicle power supply/battery. The power supply 4 comprises two backup batteries 9 that provide 12-48 hours of redundant power. Using two batteries provides primary and secondary failover power in case the main vehicle battery fails.

The backup batteries 9 are charged via a split charge system which ensures that the battery lowest on power has priority and is charged first. The split charge system has feedback protection to ensure that the backup batteries cannot back feed into the main vehicle battery, or between each other. One battery is in use (on standby to be used as a backup), and the other is being charged, with switchover between the batteries at regular pre-set intervals. The feed back protection ensures that the two batteries cannot back feed into the vehicles battery or between themselves, and they must maintain individuality to ensure correct monitoring. When the vehicle is switched off feed from the batteries will be switched off. Only when the vehicles system is energised will the batteries come into use.

Two inverters are required to supply power to the screen. The inverters need to change the 12V DC current from the batteries to a variable output of between 60 to 80V AC at around 0.05 A. A square wave at 50 Hz is suitable as long as the interference is kept to a minimum. If one of the inverters begins to fail, then a signal is sent to change over to the standby inverter.

In another embodiment, the power supply 4 can also be configured to transfer kinetic energy from the vehicle's alternator to the connected instruments, thereby ensuring that vehicle component elements are continuously supplied with power. This ensures that the windscreen 2 of the theft prevention system is supplied with power even if there is a power failure of the main power source—failure of the main power source will not cause the windscreen 2 to turn opaque mid-operation as current will still be supplied. Other devices and applications can also be supplied with power from the uninterruptable power supply 4. The uninterruptable power supply 4 in this configuration comprises the following main components:
a miniscule turbine configured for connection to the vehicle alternator or similar moving vehicle part;
a secondary battery and battery housing;
a microchip/processor configured for commanding and determining current, which will also communicate with the embedded telematics of the visual anti-theft devices remote monitoring to advise the operator of an issue and where to go to have it resolved.

The main components are all contained within a housing, with connections extending from the housing as required—for example mechanical connections to the vehicle alternator or other moving part(s) of the vehicle. Electrical cabling is used to electronically connect the elements as required.

The miniscule turbine is mechanically connected to the vehicle's alternator, so that it is driven as the alternator turns. This in turn produces electronic current which is transferred to the secondary battery. The secondary battery supplies power as required within the vehicle 1, for example in the event of failure of the main power supply, thus providing safe operation of the vehicle in question. When a user is operating the vehicle—i.e. as the vehicle travels—the kinetic uninterruptable power supply is charged, continuously storing power in case of main vehicle battery failure. After a user parks the vehicle, the windscreen returns to an opaque state as they remove the key/fob from the ignition and/or time delayed to coincide with them locking the vehicle via the key/fob and central locking.

It should be noted that in the description above, the screen 2 is described as being the front windscreen of the vehicle. However, ‘screen’ could also encompass the rear windscreen, or any other glass or transparent material within a vehicle, including side windows, mirrors, or control screens. If the security system is fitted to the rear screen, then the control system can be configured so as to receive a signal from the vehicle indicative of the vehicle being put into a reversing state, and the screen can e activated or deactivated as appropriate.

The screen and the control and communication network are described as two sub-elements of an overall theft prevention system. It should be noted that these could also be used as theft prevention systems independently of one another. All the variations of the theft prevention system outlined above are able to withstand ambient temperatures of between minus forty degrees Celsius (−40° C.) and plus one hundred and twenty degrees Celsius (+120° C.). The processor of the connectivity and remote access system described above can also have the further following functionality:
enabling the remote and localised activation and de-activation of the vehicle's headlights depending on the ambient light at the vehicles location, using weather data or similar.
enabling the remote and localised activation, de-activation and personalisation of a vehicle's climate control system depending on the ambient temperature at the vehicles location, using weather data or similar, processed in a server environment.
enabling the remote and localised scanning of a vehicle for diagnostic, checking in/out and information purposes using Near Field Communication (NFC).
enabling the automated notification to a roadside breakdown service, of a vehicle breakdown which is identified through the processing of information received from the vehicle's Controller Area Network (CAN) and information processed by the connectivity and remote access system, such as the vehicle location.
enabling contextual advertisement announcements via the vehicle's in-car entertainment system, which are sent to the vehicle following processing in a server environment using information such as the driver profile and vehicle location.

In the functions outlined above, the processor can act as a server environment, or can be in contact with a remote server to form part of a greater server environment. Alternatively, the server environment can be located fully remotely, and can enable the functionality outlined directly (i.e. bypassing the processor 5). The processor can be further configured to impose limits on the vehicle depending on pre-set levels set by a third party such as the vehicle insurer. For example, the set of a maximum speed limit of 60 mph for new drivers. The processor can be further configured to create and update profiles of drivers using information received from the vehicle's Controller Area Network (CAN), such as speed, and information processed by the other elements of the connectivity and remote access system, such as the vehicle location. This profile can then be used as a theft identification method and/or supporting information for a third party service, such as vehicle insurance. The processor can be further configured to warn drivers of a high risk route or parking location through the notification of a warning on a smart device or an in-car entertainment system, which is received following information being processed within in a server environment. The processor can be further configured to warn drivers of a requirement to replace a part or complete a service depending on the processing of information received from the vehicle's Controller Area Network (CAN) and the recording of information on to a system by the driver and/or a third party, such as a repair garage. The system described above can also be modified for use in a home, facility or other building to act as a burglary prevention system, with the elements described or substantially similar elements incorporated into the structure of the building as necessary rather than the structure of the vehicle, and the key fob being a building key fob rather than a vehicle key fob.

1-81. (canceled)

82. A connectivity and remote access system for a vehicle, comprising:
a plurality of wireless communication devices and at least one processor, the wireless communication devices and the at least one processor configured for inter-communication,
at least one of the wireless communication devices physically separate from the remainder of the system, the wireless communication devices and processor configured so that
communication between the physically separate device and at least one other integral device is required before the processor will authenticate the user for system use.

83. A connectivity and remote access system as claimed in claim 82 wherein the at least one other integral wireless communication device is located within the vehicle ignition circuit.

84. A connectivity and remote access system as claimed in claim 83 wherein a further wireless communication device is located within the vehicle engine bay.

85. A connectivity and remote access system as claimed in claim 82 wherein a further wireless communication device is located within the vehicle frame.

86. A connectivity and remote access system as claimed in claim 82 wherein the physically separate device is located in a key fob.

87. A connectivity and remote access system as claimed in claim 1 further comprising a secondary power supply configured to supply non-motive electrical power to the vehicle in the event of failure of the main vehicle power supply.

88. A connectivity and remote access system as claimed in claim 87 wherein the secondary power supply comprises at least two batteries.

89. A connectivity and remote access system as claimed in claim 88 wherein the secondary power supply further comprises a split charge system configured to charge the batteries via the vehicle main power supply.

90. A connectivity and remote access system as claimed in claim 89 wherein the split charge system is configured to preferentially charge the battery lowest on power.

91. A connectivity and remote access system as claimed in claim 89 wherein the split charge system has feedback protection configured to ensure that the backup batteries cannot back feed into the vehicle main power system or each other.

92. A vehicle as claimed in claim 88 wherein the secondary power supply is configured to have one battery on standby and one in use, and to switch between the batteries at pre-set intervals.

93. A connectivity and remote access system as claimed in claim 87 wherein the secondary power supply further comprises at least two inverters configured to alter the DC current from the batteries to an AC current.

94. A connectivity and remote access system as claimed in claim 93 wherein the inverters are configured to alter the current to substantially between 60 and 80 Volts AC at substantially 0.05 Amps.

95. A connectivity and remote access system as claimed in claim 93 wherein the inverters are configured to alter the current to a square wave output at substantially 50 Hz.

96. A connectivity and remote access system for a vehicle as claimed in claim 82 wherein the processor is configured to enable the remote and localised activation and de-activation of the vehicle's headlights depending on the ambient light at the vehicles location, using weather data or similar, processed in a server environment.

97. A connectivity and remote access system for a vehicle as claimed in claim 82 wherein the processor is configured to enable the remote and localised activation, de-activation and personalisation of a vehicle's climate control system depending on the ambient temperature at the vehicles location, using weather data or similar, processed in a server environment.

98. A connectivity and remote access system for a vehicle as claimed in claim 82 wherein the processor is configured to enable the remote and localised scanning of a vehicle for diagnostic, checking in/out and information purposes using Near Field Communication (NFC).

99. A connectivity and remote access system for a vehicle as claimed in claim 82 wherein the processor is configured to enable the automated notification to a roadside breakdown service, of a vehicle breakdown which is identified through the processing of information received from the vehicle's Controller Area Network (CAN) and information processed by the connectivity and remote access system, such as the vehicle location.

100. A connectivity and remote access system for a vehicle as claimed in claim 82 wherein the processor is configured to enable contextual advertisement announcements via the vehicle's in-car entertainment system, which are sent to the vehicle following processing in a server environment using information such as the driver profile and vehicle location.

101. A connectivity and remote access system for a vehicle as claimed in claim 82 wherein the processor is configured to impose limits on the vehicle depending on pre-set levels set by a third party such as the vehicle insurer. For example, the set of a maximum speed limit of 60 mph for new drivers.

102. A connectivity and remote access system for a vehicle as claimed in claim 82 wherein the processor is configured to create and update profiles of drivers using information received from the vehicle's Controller Area Network (CAN), such as speed, and information processed by the connectivity and remote access system, such as the vehicle location. This profile is then used as a theft identification method and/or supporting information for a third party service, such as vehicle insurance.

103. A connectivity and remote access system for a vehicle as claimed in claim 82 wherein the processor is configured to warn drivers of a high risk route or parking location through the notification of a warning on a smart device or an in-car entertainment system, which is received following information being processed within in a server environment.

104. A connectivity and remote access system for a vehicle as claimed in claim 82 wherein the processor is configured to warn drivers of a requirement to replace a part or complete a service depending on the processing of information received from the vehicle's Controller Area Network (CAN) and the recording of information on to a system by the driver and/or a third party, such as a repair garage.

105-139. (canceled)
